(19) United States
(12) Patent Application Publication
(10) Pub. No.: US 2015/0235275 A1
(43) Pub. Date: Aug. 20, 2015

(54) CROSS-DEVICE PROFILE DATA MANAGEMENT AND TARGETING

(71) Applicant: Turn Inc., Redwood City, CA (US)

(72) Inventors: Neil Shah, Redwood City, CA (US); Emile Litvak, Redwood City, CA (US); Vishal Shah, Redwood City, CA (US); Charlotte Narvaez, Redwood City, CA (US)

(73) Assignee: Turn Inc., Redwood City, CA (US)

(21) Appl. No.: 14/185,092

(22) Filed: Feb. 20, 2014

(51) Int. Cl. G06Q 30/02

(52) U.S. Cl. CPC G06Q 30/0269

(57) ABSTRACT

For each device represented in a device graph of different sets of related devices, user profile and advertisement activity data are periodically obtained and associated with such device. For each set of related devices, an aggregated user profile graph is formed either by copying each related device's user profile data to the user profile data of the other related devices based on the device graph or each related device's user profile data is referenced with the user profile data of each other related device based on the device graph while maintaining such each related device to be separately associated with its user profile data. Different unique aggregated profiled identifiers are associated with different sets of related devices, and the aggregated profile device graph is provided in a database that is accessible by a processor that is programmed to perform targeted advertising or marketing engagement over a computer network.

### TECHNICAL FIELD OF THE INVENTION

The present invention relates to on-line advertising, and more specifically to identifying, targeting, and analyzing user data across multiple devices.

### BACKGROUND

In online advertising, internet users are presented with advertisements as they browse the internet using a web browser or mobile application. Online advertising is an efficient way for advertisers to convey advertising information to potential purchasers of goods and services. It is also an efficient tool for non-profit/political organizations to increase the awareness in a target group of people. The presentation of an advertisement to a single internet user is referred to as an ad impression.

Billions of display ad impressions are purchased on a daily basis through public auctions hosted by real time bidding (RTB) exchanges. In many instances, a decision by an advertiser regarding whether to submit a bid for a selected RTB ad request is made in milliseconds. Advertisers often try to buy a set of ad impressions to reach as many targeted users as possible given one or more budget restrictions. Advertisers may seek an advertiser-specific action from advertisement viewers. For instance, an advertiser may seek to have an advertisement viewer purchase a product, fill out a form, sign up for e-mails, and/or perform some other type of action. An action desired by the advertiser may also be referred to as a conversion.

Advertisers may prefer to target a particular group of users when presenting an advertisement as part of an advertising campaign. Additionally, advertisers may be faced with a very large number of different groups of users. Advertisers and their agents are continually seeking ways to improve techniques for efficiently and reliably identifying, targeting, and analyzing users and associated user data.

### SUMMARY OF THE INVENTION

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In general, certain embodiments of the present invention provide mechanisms for facilitating on-line advertising or marketer engagement over a computer network is disclosed. A device graph is provided, and such device graph represents a plurality of devices and a plurality of relationships between specific related ones of the devices that have been determined to be associated with a same user or a closely related set of users based on user on-line activity with such devices. The device graph includes a user identifier for each device. For each device of at least a portion of the device graph, user profile data and advertisement or marketer engagement activity data is periodically obtained and associated with such device's user identifier. For each set of related devices, one of the following processes is performed: (i) a data distribution procedure that includes copying such related device's user profile data to each other related device based on the device graph so as to form an aggregated profile device graph, or (ii) a data traversal setup procedure that includes referencing each related device's user profile data with the user profile data of each other related device based on the device graph while maintaining such each related device to be separately associated with its user profile data so as to form an aggregated profile device graph. The data distribution and the data traversal procedure each include associating different unique aggregated profiled identifiers with different sets of related devices, and the aggregated profile device graph is provided in a database that is accessible by a processor that is programmed to perform targeted advertising or marketer engagement over a computer network.

In a specific implementation, the user identifier is associated with a physical device identifier or an application identifier. In another aspect, the device graph comprises a plurality of confidence scores associated with each relationship that indicates a probability that the corresponding related devices are associated with a same user or a closely related set of users. In one aspect, at least a portion of the relationships are between specific related ones of the devices that have been determined to be associated with a closely related set of users in the form of a household based on user on-line activity with such devices. In a specific feature, the user profile data and advertisement activity data that is obtained periodically for each device originates from a plurality of different data sources including a plurality of advertisers or advertiser agents, one or more bid management systems, and a plurality of third party sources.

In one embodiment, copying or referencing each related device's user profile data with respect to another related device only occurs when the provided device graph indicates a relationship between such related device and other related device that has a confidence value above a predetermined threshold. In another embodiment, the data traversal setup procedure is performed such that each set of related devices in the aggregated profile device graph contains references to its other related devices, such that, separate user profile data are persisted and confined to its associated related device. For instance, the user profile data of each set of related devices is obtainable through such set of related devices' references to each other.

In a further implementation, the method further includes (i) determining campaign user and device constraints for each of a plurality of advertisements; (ii) at a communication interface of a bid determination platform, receiving a bid request associated with user data and/or device data for a first device; (iii) obtaining user profile data for the first device and other devices related to the first device based on the user data and/or device data of the bid request and the aggregated profile device graph; (iv) determining a plurality of bids for a portion of the advertisements via a computer processor of the bid determination platform based on the user data, the device data, and the user profile data for the first device and its other related devices meeting the campaign user and device constraints associated with each advertisement from the portion of advertisements; and (v) transmitting the optimum one of the bids, along with a reference to the associated advertisement, via the communication interface towards a sender of the bid request.

In a further aspect, the method (i) includes determining user and device constraints for a content portion; (ii) at a communication interface of a marketing platform, receiving a content request associated with user data and/or device data for a first device; (iii) obtaining user profile data for the first device and other devices related to the first device of the content request based on the user data and/or device data of the content request and the aggregated profile device graph; (iv) determining via a computer processor of the marketing platform whether to provide the content portion based on the user data, the device data, and the user profile data for the first device of the content request and its other related devices meeting the content user and device constraints; and (v) if the content user and device constraints are met, transmitting a reference to the content portion via the communication interface towards a sender of the content request.

In a further aspect, at least one of the device constraints specify a sequencing of device types for displaying the associated advertisement. In yet a further aspect, at least one of the device constraints specifies a frequency cap for displaying the associated advertisement across related devices.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of certain embodiments of the invention and the accompanying figures which illustrate by way of example the principles of the invention.

### BRIEF DESCRIPTION OF THE DRAWINGS

FIG. 1 is a diagrammatic representation of the use of multiple devices by related users.

FIG. 2A illustrates a representation of a first device graph representing relationships between users of a plurality of different devices D1˜D5.

FIG. 2B illustrates an updated second device graph, which includes a change in the relationships between devices D1˜D5.

FIG. 3 is a flow chart illustrating a procedure for facilitating the aggregation of user profile and on-activity data across devices in accordance with one embodiment of the present invention.

FIG. 4A is a table that represents user profile data, as well as activity data, for a plurality of devices.

FIG. 4B is a table that illustrates partial results of a data aggregation process that includes distributing user data across related devices in accordance with one embodiment of the present invention.

FIG. 4C is a table that illustrates partial results of a data aggregation process that includes setting up references to related devices for facilitating a traversal process in accordance with an alternative embodiment of the present invention.

FIG. 5 illustrates a process for setting up a campaign in accordance with one implementation of the present invention.

FIG. 6 is a flow chart of a process for bid request management in accordance with one embodiment of the present invention.

FIG. 7 is a flow chart illustrating a technique for cross-device data compilation in accordance with a specific implementation of the present invention.

FIG. 8 illustrates a procedure for optimization of campaign execution in accordance with one embodiment of the present invention.

FIG. 9 is a flow chart illustrating a reporting procedure in accordance with one simple embodiment of the present invention.

FIG. 10 is a diagrammatic representation of a simplified computer network in which advertisement processes may be implemented.

FIG. 11 illustrates a typical computer system that, when appropriately configured or designed, can serve as a system for implementing at least portions of the process embodiments described herein.

### DETAILED DESCRIPTION OF THE SPECIFIC EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

The same user or household may anonymously use multiple devices. For example, a particular user may login to a desktop computer and then use a mobile device without a same login. In another example, a particular household of users may use multiple browsers and applications on multiple devices with different or no login identities. Such disparate device use may make it difficult for an advertiser to recognize individual user activity on different devices as the same user or as belonging to the same household. If a particular user does not log in with a single identity when she uses her different devices, any user profile data or on-line activity data that is associated with each of her individual devices are not initially associated or aggregated together across all her devices. Thus, it may also be difficult to target a user or closely related group of users across multiple devices, especially when personal login information is missing or only sometimes associated with some of the related devices.

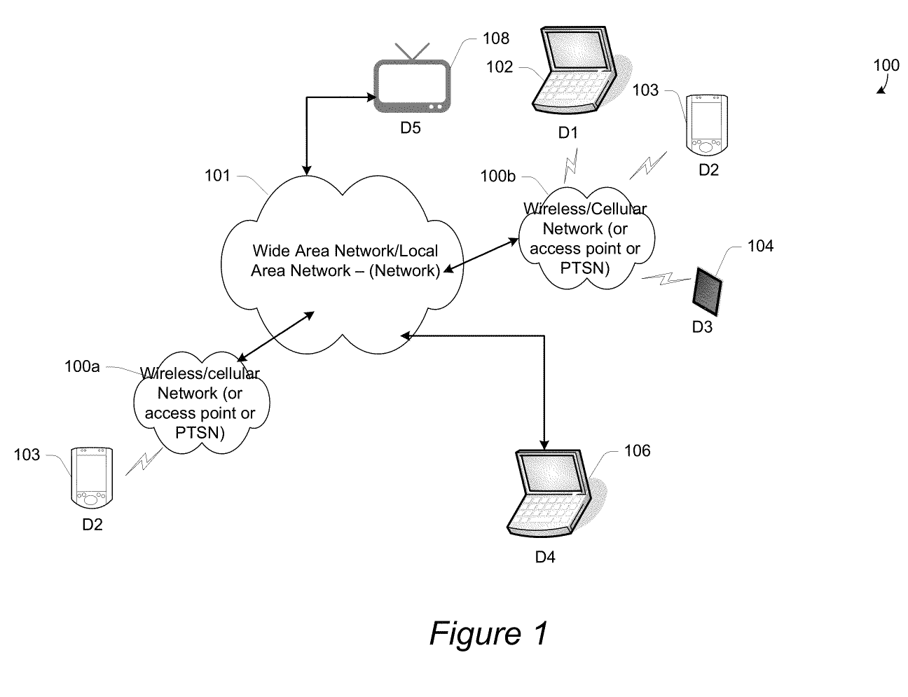

FIG. 1 is a diagrammatic representation of on-line use of multiple devices by subsets of related users. For instance, devices D1 (102) and D2 (103) may belong to a same user, while devices D3 (104), D4 (106), and D5 (108) may belong to a same household of users. A user or household of users may use these devices through any number and type of devices and computer networks, such as through a wireless or cellular network (or a plain telephone system network or PTSN) 100a or 100b and one or more wide area (WAN) and local area networks (LAN) networks 101. A user may also use a device via a Bluetooth connection to a computer that is connected to a network. There are any number and type of device and network configurations through which a device may be used by one or more users.

Devices that are described herein may include any number and types of physical and/or virtual devices, such as smartphones or other mobile devices including browsers and/or apps, desktop or laptop computer including browsers, interactive television systems including browsers and/or apps, tablets, smartwatches, wearable devices, etc. The term “device” is used herein to refer to the physical device itself or the software module (e.g., app or browser software) through which such physical device communicates with and identified by other devices or servers via a computer network.

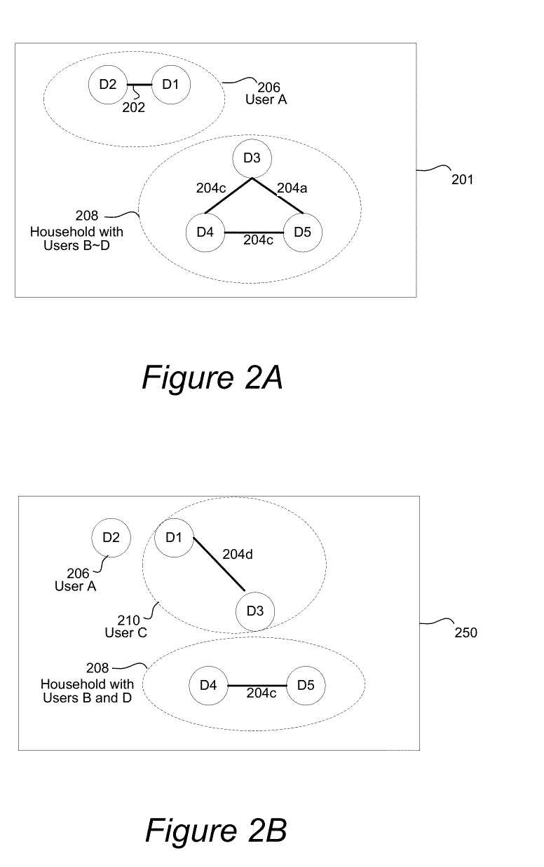

In general, statistical techniques can be used to analyze the on-line activity and user profile data of various devices and generate a device graph that associates various sets of devices and their one or more users together. FIG. 2A illustrates a representation of a first device graph 201 representing relationships between users of different devices D1˜D5. As shown, a relationship link 202 indicates that devices D1 and D2 are related, while, links 204a, 204b, and 204c illustrate that devices D3, D4, and D5 are related to each other. For example, a single user 206 (User A) may own and use both a desktop computer D1 and a smartphone device D2. In another relationship example, a household of users 208, which includes a mom (User B) and two daughters (Users C and D), may share a laptop computer D3, a tablet computer D3, and an interactive television system D5.

The relationships between devices and their users may change over time. FIG. 2B illustrates an updated second device graph 250, which includes a change in the relationship of the devices D1˜D5 as compared to the relationships of FIG. 2A. As shown, there is a new relationship link 204d between devices D1 and D3 and no longer a relationship between devices D1 and D2. For instance, a daughter User C (210) has left household (208) with tablet computer D3 and perhaps purchased the desktop computer D1 from User A (206). As a result, device D2 (of User A) is no longer associated with any other devices since user A (206) now only owns the one device D2. Devices D1 and D3 (of User C) are associated through link 204d, and devices D4 and D5 (of Household 208 with Users B and D) are associated through link 204c.

According to various embodiments, techniques and mechanisms described herein utilize device graphs to aggregate user profile and on-activity data. This aggregated user data may then be used to anonymously target and analyze user profile and on-line behavior data across multiple devices that are used by the same user or a set of closely related users, such as a household, to facilitate on-line targeted advertising.

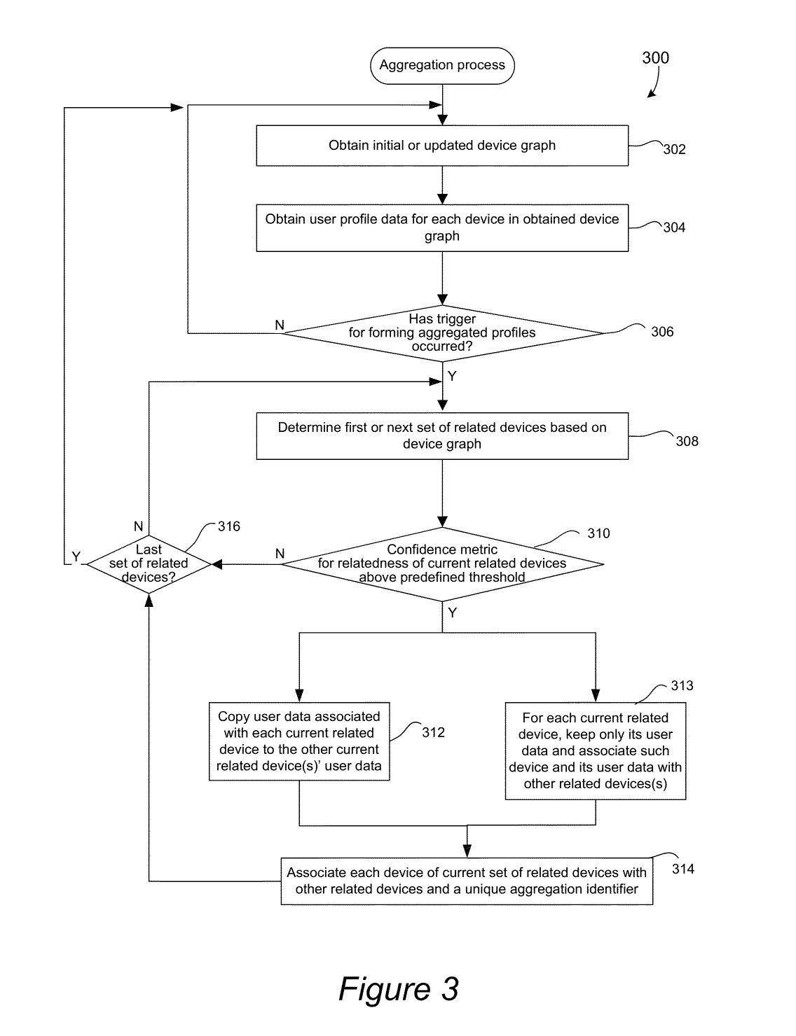

Any suitable technique may be used to anonymously aggregate user profile data across multiple related devices. FIG. 3 is a flow chart illustrating a procedure 300 for facilitating the aggregation of user profiles and on-activity data across devices in accordance with one embodiment of the present invention. An initial or updated device graph may be obtained in operation 302.

A device graph that specifies relationships between devices (including apps, browsers, or the like) as belonging to the same user or a closely related set of users may be obtained in any suitable manner. The data that is used to generate a device graph may include identifiers for each specific device and/or user of such device. For example, when a user requests a page through a device's browser or app, the page request will generally contain a unique device identifier and sometimes a device type identifier. This device identifier (and device type) may also be associated over time with various user data that indicates various types of user on-line activity, user location, etc. This user data can be analyzed to make inferences to generate any number and type of device graphs. For example, if several devices use the same IP address, such as provided for a home network, these devices may be related to an aggregated user, such as a household. If one of these devices consistently moves to a same work location at about the same time of day and then another desktop or laptop device is used at the same location, the desktop/laptop device may be inferred to be related to the mobile device and its same user.

In general, a statistical approach to determining which devices are likely related to a same person or closely related group of people may be used to generate a device graph. Additionally, this device graph may be supplemented by known relatedness information, such as user login from various devices. For example, if a user logs in with a same username on two different devices, it may be inferred that the two devices are being used by the same person, even when some user activity on the two devices does not include a login session.

Although the following description refers to a single device graph, it is contemplated that multiple device graphs can be utilized for various embodiments of the present invention. When multiple device graphs are used, they may be combined or averaged together, for example, to combine relationships and confidence scores. Inconsistencies may be filtered out. For instance, relationships that are present in a single device graph and not present in other graphs can be filtered out and optionally based on a predefined confidence threshold.

User profile data may then be obtained for each device listed in the device graph in operation 304. User profile data may be continually obtained for devices in the device graph as well as other devices that are not in the device graph, even after the device graph is generated (or updated). In general, user profile data may be obtained from a variety of data sources, such as 1^{st} party sources (advertisers) or other 3^{rd} party sources.

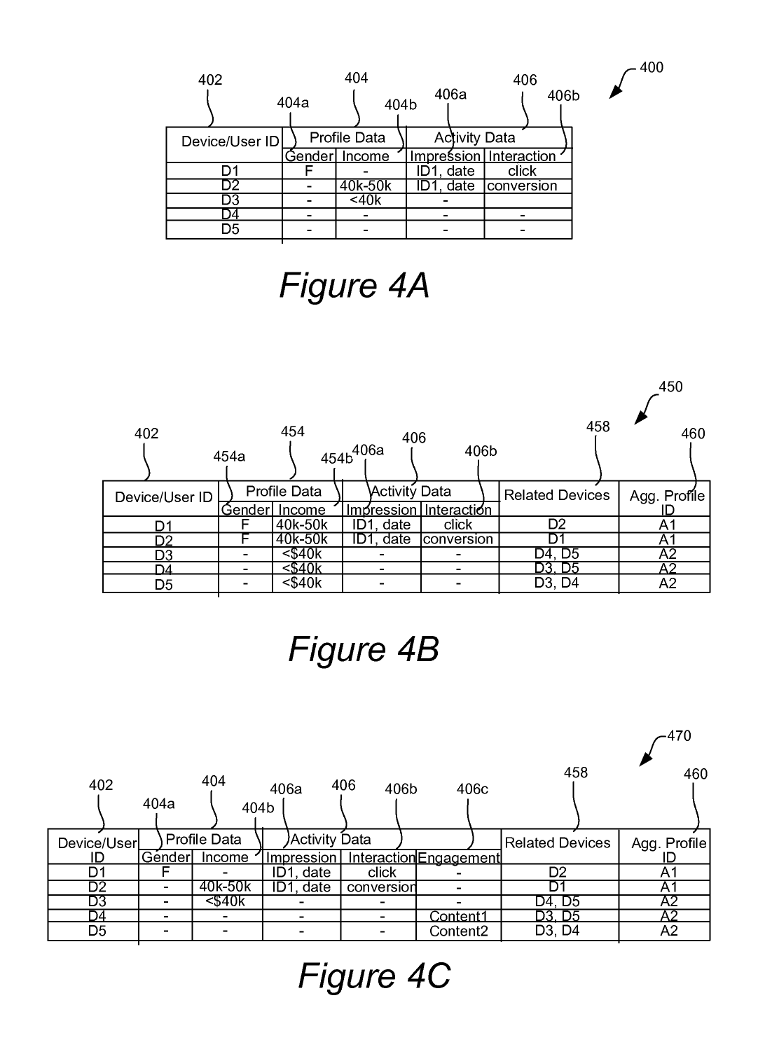

FIG. 4A is a table 400 that represents user profile data, as well as activity data, for a plurality of devices. As shown, the table 400 includes a column for a device and/or user identifier 402. The device identifier may include a unique device identifier and a device type, while the user identifier may be an anonymized and unique user identifier that is generated by the device, a service, advertiser, or a bid management or demand side platform (DSP).

The table 400 may also include any number of user profile columns 404, e.g., gender 404a and income 404b. As shown, a device D1 is associated with a gender that is specified as female (F), while the other devices D2-D5 are not associated with a specified gender. Similarly, device D2 pertains to a user income value of $40 k-50 k, and device D3 pertains to a user income of less than $40 k. Although only two user characteristic types are illustrated, each device may be associated with any number and type of user profile characteristics.

Each device may also be associated with its own activity data 406, including impression data 406a (e.g., impression identifier and time that the impression was served to the device) and user activity indicator 406b that specifies various interactions that the user had with respect to the particular impression and a time at which such interaction occurred. Interactions may include clicks, downloads, site visits, mouse overs, video/audio play (or pause, forward, rewind, etc.), conversions, an engagement heatmap, view time, view based actions, etc. A heatmap may illustrate a quantitative level of activity with respect to an impression or other content. Other activity data, besides data pertaining to impressions, relates to marketing engagement activity or data 406c. For example, marketing engagement may include an advertiser providing particular content on a product site so as to engage particular audience segments in various activities (such as publications, surveys, discussions, etc.) As the device receives more impressions or engages in various marketing activities or content, multiple entries may be generated for the multiple impressions or engagements.

Although the illustrated device data table 400 shows a single entry for each device that includes user profile data and impression data for a single impression, other data representations are contemplated. For example, one or more device entries may indicate one or more user profile characteristics. Likewise, one or more device entries may indicate one or more impression data sets. That is, each impression's data may be listed in a separate entry or listed together in a single device entry. The user profile data entries may also be separated from the impression data entries.

It may be determined whether a trigger for forming (or referencing) aggregated profiles has occurred in operation 306. A trigger may take any suitable form. For example, a trigger may occur periodically in any suitable time intervals. Profile aggregation may be triggered each time a new piece of user profile data is generated or updated or after a particular amount of new user profile data is collected, obtained, or received. Other trigger factors may include reaching a threshold number of devices with new user profile data, time lapse since last collected data or interaction analysis, etc.

If a trigger has not occurred, a device graph and/or user data may continue to be obtained. After a trigger occurs, a first set of related devices may be determined based on the device graph in operation 308. Based on the device graph 200 of FIG. 2A, it may first be determined that devices D1 and D2 are related.

It may then be determined whether a confidence metric for the relatedness of the current set of devices is above a predefined threshold in operation 310. Each relationship may be associated with one or more confidence metrics such as a probability that the devices are related. Before data aggregation is performed, it may first be determined whether the confidence in the relatedness is above a predetermined threshold. The threshold may be selected based on a personal preference as to the tradeoffs between accuracy and the amount of data spread/referenced across devices. For example, a confidence threshold of 5% would result in a huge data spread and low accuracy, while a confidence threshold of 100% would result in a small spread that is very accurate.

If the threshold is met, a user data aggregation process may be performed or set up. Two different aggregation techniques are illustrated (312 and 313) although only one aggregation technique would typically be implemented. In a data distribution technique, user data that is associated with each current related device is copied to the other current related device(s)′ user data in operation 312. Each device in the current related devices may be associated with the other related device(s) and a unique aggregation profile identifier in operation 313.

FIG. 4B is a table 450 that illustrates a data aggregation process that includes distributing user data across related devices in accordance with one embodiment of the present invention. As shown, the user data specifying a female gender for device D1 from FIG. 4A is copied to the user data for device D2 in FIG. 4B since devices D1 and D2 are related. Likewise, the user data that specifies an income of $40 k-50 k is copied from device D2 to device D1. Each device in the current related devices D1 and D2 may be associated with its other related device D2 and D1 (column 458), respectively, and a unique aggregation profile identifier (A1) in column 460.

The user data copy process may be repeated for all sets of related devices if their confidence value is above the predefined threshold. As shown, user income <$40 k is copied from device D3 to the other related devices D4 and D5 in a repeat of operation 312 of FIG. 3. Each device in the current set of related devices D3-D4 may also be associated with its other related devices and a unique aggregation profile identifier (A2) in a repeat of operation 314. For example, device D3 is associated with devices D4 and D5, while device D4 is associated with related devices D3 and D5. Likewise, device D5 is associated with related devices D3 and D4.

In a setup procedure for data traversal, each current related device keeps only its own user data and such device and its user data are associated with the other related device(s) in operation 313. FIG. 4C is a table 470 that illustrates a data aggregation process that includes setting up references to related devices for facilitating a traversal process in accordance with an alternative embodiment of the present invention. As shown, each device maintains its own set of user data. However, each device is also associated with its related devices in column 458, as well as a unique aggregation identifier in column 460. This table 470 may later be traversed to find aggregated data for related devices as further described below.

The aggregated profiles or “aggregated user profile graph” that include either copied user data or references to related devices may be obtained for each updated device graph. When a new aggregated profile graph is generated or updated, the previous aggregated profile graph (and previous device graph) may be maintained and stored so as to allow analysis of how the device relationships and corresponding user data has changed over time.

The data traversal setup results in an aggregated profile graph containing references to related device/profiles, such that, rather than duplicating the data across related devices/users, the separate data sets are persisted and confined to each user/device identifier. However, this aggregate profile graph can be used in real time for each bid opportunity so that the graph of related device identifiers is traversed and all data of a specific aggregated profile/user can then be known. In this implementation, user data for each device stays separate and the aggregate profile graph and its data can change at any frequency without disturbing the data sets in these multiple profiles. Keeping the devices and their data attributes separate allows for a much more granular understanding of user behavior during data analysis.

In recent years, the amount of ad impressions sold through real time bidding (RTB) exchanges has experienced a tremendous growth. RTB exchanges provide a technology for advertisers to algorithmically place a bid on any individual impression through a public auction. This functionality allows advertisers to buy inventory in a cost effective manner and to serve ads to the right person in the right context at the right time. However, in order to realize such functionality, advertisers need to intelligently evaluate each impression in real time or near real time. Demand-side platforms (DSPs) provide real time bid optimization techniques to help advertisers very quickly determine a bid value for each bid request that is sent from a seller of an impression. For instance, a DSP may determine a bid value in milliseconds for close to a million bids per second based on information provided with each bid request that is sent from a publisher, for example, via an RTB exchange.

After user data is distributed across related devices or setup for data traversal, the aggregated profile user data may be utilized for various purposes. For example, a campaign may be set up and executed based on aggregated profiles and their related devices. More particularly, particular audience segments may be targeted across devices or a sequence of devices. Various combinations or aspects of the aggregated user profile data may also be analyzed and reported to determine how to optimize advertisement campaigns. Other uses of aggregated profiles and device graphs may also include marketing engagement for particular aggregated profiles across devices. For example, specific content may be provided to particular audience segments across devices of aggregated profiles.

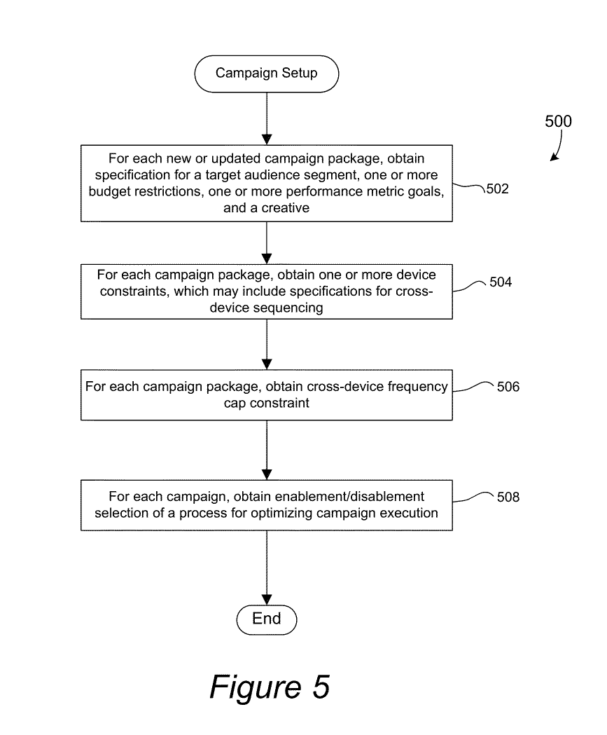

FIG. 5 illustrates a process 500 for setting up a campaign in accordance with one implementation of the present invention. According to various embodiments, the method 500 may be performed at a computing system configured to provide advertising campaign management services. For instance, the system may be configured to establish parameters for different advertising campaigns, to receive advertising opportunity bid requests from a real time bid exchange system via a network, to place bids on at least some of the received bid requests, and to evaluate the performance of the advertising campaigns.

Initially, a specification for a target audience or segment, one or more budget restrictions, one or more desired performance metric goals, and a creative may be obtained for each new or updated campaign package of a campaign in operation 502. In some instances, the DSP may assist the advertiser in configuring the advertising campaign. According to various embodiments, the advertiser may designate an initial target audience, and the DSP may recommend modifications to the initial target audience to provide improved advertising campaign performance as described further below.

In some implementations, a target audience for an advertising campaign may be selected by designating one or more data sources and/or data categories. Each data source may be provided by a data service provider. The data service provider may provide data for determining whether a potential advertising audience member associated with an incoming advertising opportunity bid request falls within a designated category.

For example, a data service provider may provide a data source that distinguishes between many advertising opportunity bid requests based on geographic region within the United States. Categories within this data source may include states, major cities, zip codes, and direct marketing areas (DMAs) within the United States.

As another example, a data service provider may provide a data source that distinguishes between many advertising opportunity bid requests based on estimated yearly income. Categories within this data source may include income ranges such as “$15,000-$30,000” and “$30,000-$45,000”.

According to various embodiments, data categories may distinguish between potential advertising audience members based on any of potentially many different factors. These factors may include, but are not limited to: age, sex, race, income, purchasing patterns, purchasing intent, personal interests, education, profession, consumer preferences, political affiliations, and geographic region.

One or more device constraints, which may include specifications for cross-device sequencing, may also be provided for each campaign package in operation 504. An advertiser may initially provide an initial targeted device constraint for each package, and the DSP may recommend modifications to the initial targeted device to provide improved advertising campaign performance as described further below.

In certain embodiments, one or more device constraints may be designated by specifying a particular target device, such as a mobile or desktop/laptop computer, for displaying a selected advertisement creative. An advertiser may specify a sequence of devices for consecutively displaying impressions. For example, the sequence may include a particular creative being displayed first on a user's mobile and then on a user's desktop computer.

A cross-device frequency cap for each campaign package may also be obtained in operation 506. For instance, the advertiser can specify how many times a user is shown a particular creative, regardless of which device the creative is displayed.

In certain embodiments, enablement or disablement selection of a process for optimizing campaign execution may also be obtained for the campaign in operation 508. That is, the DSP may provide an interface for the advertiser to choose whether recommendations for new targeted audience segments, devices, device sequences, or frequency caps are provided to the advertiser by the DSP during the campaign execution.

According to various embodiments, different constraints may be linked together, for instance via Boolean logic. Boolean logic may include operators such as “AND” and “OR”. Data categories that are linked together may form a data segment that can be used to select advertising opportunity bid requests for bid placement. For instance, one data segment is labeled Segment 1, composed of data categories A, B, C, and D, and formulated according to the following equation.

Segment 1=A OR B OR (C AND D)

In this example, the data category A may represent one audience segment subset such as “males aged 30-45 on mobile devices” while the data category B may represent a different audience subset such as “females aged 28-40 on mobile devices”. The data categories C and D may represent other audience subsets such as “ages 18-30” and “an income of more than $80,000 per year”.

According to various embodiments, a data segment may be used to select incoming advertising opportunity bid requests for bid placement. For instance, an advertising opportunity bid request may be associated with an individual identified as likely being female and 32 years of age. Such an ad request would not fall into the data category A or in the combined category (C AND D) but would fall into the category B in the above example.

In particular embodiments, the ordering of the categories within a data segment may influence bid placement. For instance, an advertising campaign may be allotted a designated budget to spend within a given time period. If more advertising opportunity bid requests that match the criteria specified by the data segment are received during the time period than would be possible to purchase using the designated budget, then some data categories may be prioritized over other data categories. For instance, one possible order priority may prioritize category A first, category B second, and the combined category (C AND D) third in the above example based on the order in which they are listed. However, other prioritization schemes are possible.

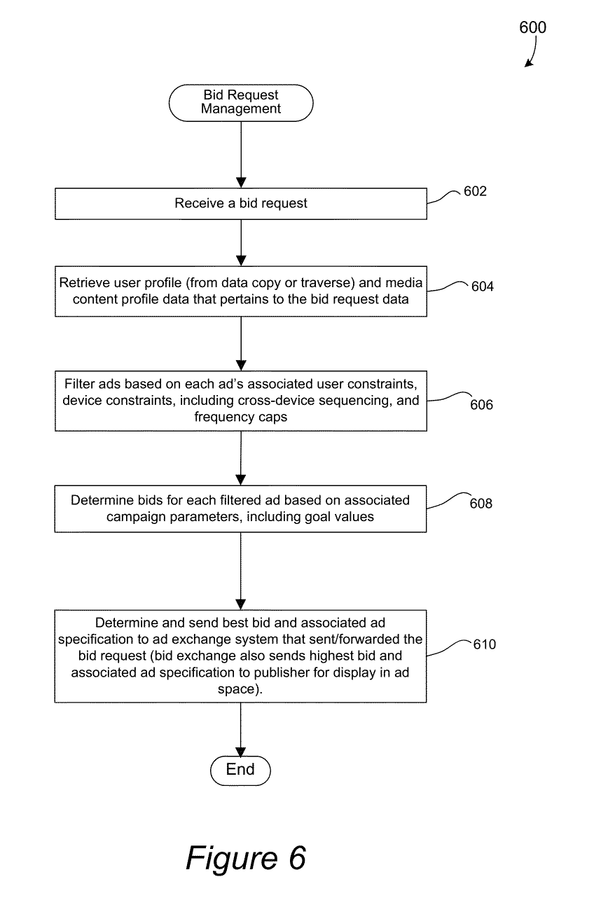

FIG. 6 is a flow chart of a process 600 for bid request management in accordance with one embodiment of the present invention. This bid management process of FIG. 6 is described with respect to a single bid request received and handled by a single DSP. However, it is understood that real-time bidding involves a large number of bid requests sent by a large number of different publishers to a large number of real-time bid exchange systems and respective DSPs or advertiser management systems.

Initially, a bid request having data for a first set of variables may be received in operation 602. The data for a first set of variables may include a user/device ID and media content ID (e.g., u and w). The terms user ID and device ID are used interchangeably herein.

User profile and/or media content profile data may also be provided by the publisher with the bid request. User profile and media content profile data that pertains to the bid request data may be retrieved in operation 604. For example, this retrieval process may be performed to obtain user or media content data that was not provided in the bid request if a user ID and/or media content ID (u and w) is provided in the bid request and user and media content profile data is retrievable. For instance, the DSP retrieves user and media content profiles (and/or other type of data) that were previously stored and mapped to the user ID and media content ID (u and w) provided in the bid request. For instance, user profile data that is associated with devices that are related to the device associated with the current user ID may also be retrieved. However, either profile may also be empty if u or w is new to DSP or if u or w is not provided in the bid request sent to DSP.

The user profile of user u may include any characteristics that were, are, or can be associated with the particular user u. To protect a user's privacy, user profile data may be stored with an anonymized type of user identifier, such as an arbitrary or randomized identity, rather than the user's actual name, specific residency, or any other type of user identifying information. Examples of user profile data for the particular anonymized user u may include descriptive data, such as personal or professional interests, employment status, home ownership, knowledge of languages, age, education level, gender, race and/or ethnicity, income, marital status, religion, size of family, field of expertise, residential location (country, state, DMA, etc.), travel location, or predictive data, such as likelihood to consume content or perform an activity, such as clicking on an ad, visiting a page or purchasing a product or service, in the near future, etc.

The user profile data may also include browsing history information, such as pages visited, amount of time per page viewing, links clicked on, searches performed, actions or interactions taken, amount and type of purchases made, etc. The browsing history information may be expressed using any suitable one or more metrics, such as count, absolute or relative value, average, mean, frequency, time duration, etc. The user profile of user u may also include contextual data, such as where the user is currently located, the weather at such location, current events at such location, etc. For instance, the ad request may include a GPS (global positioning satellite) value or access point location for the user u, and other contextual data may be scraped from other databases, such as a weather, time of day, or entertainment event web site for such location. The media content profile may identify various characteristics of the web page or ad space or ad placement that is available for purchase, such as one or more content category, ad placement position (e.g., top, side, or bottom of page), ad type (e.g., banner, video, pop-up), brand safety (e.g., absence of alcohol, violence, drugs, competitive brands), page quality (e.g., absence of cluttering images, prominent display of the ad), etc.

Some data that is related to the bid request may be only known by the seller and not obtainable by the DSP unless the seller provides such data in the bid request. For example, the publisher may retain data regarding whether the user has visited a particular on-line web site through the publisher's site. Other data related to the bid request may be obtainable by the DSP from sources other than the bid request. For instance, the DSP may obtain user demographics data based on a provided user ID or media content ID provided in the bid request, as well as the aggregated profile device graph.

If user profile data was previously copied and distributed across related devices, user profile data for the device's aggregated profile, which includes user profile data from related devices, may then be retrieved. If user profile data has been set up for data traversal, user profile data may be retrieved by traversing the aggregated user device graph and collecting user profile data that is associated with the different related devices for the particular user/device u associated with the bid request. For example, if bid request specifies a user/device identifier D1 (from FIG. 4C), user profile data that specifies a female gender may be retrieved from the entry for device D1. The related device D2 may also be obtained from such D1 entry, and then the user profile data that specifies an income of $40 k-50 k may also be retrieved from the related device D2's entry so that the current bid request is associated with a female user having an income of $40 k-50 k.

In general, the DSP may run various advertisement optimization algorithms to find the best ad for u and w of the bid request. This advertisement optimization may include optimizing for the ads' campaign goals while satisfying constraints. The DSP may work with a variety of advertisers who utilize different campaign types. The campaigns may utilize performance goals for each package or segment of users or media content. That is, different packages may have a different set of constraints and different performance metric goals. A performance metric may include a cost-per-click (CPC), cost-per-action (CPA), click-through-rate (CTR), or action-rate (AR) although CPA is used herein to refer to any type of performance metric or goal. The packages of a particular campaign may have the same ad or a custom ad for the particular segment of users or media content.

In some implementations, techniques and mechanisms may be described herein as solving “optimization” problems or as “optimizing” one or more parameters. It should be noted that the term optimize does not imply that the solution determined or parameter selected is necessarily the best according to any particular metric. For instance, some optimization problems are computationally intense, and computing the best solution may be impractical. Accordingly, optimization may involve the selection of a suitable parameter value or a suitably accurate solution. In some instances, the suitability of a parameter value or solution may be strategically determined based on various factors such as one or more computing capabilities, problem characteristics, and/or time constraints.

The DSP may filter ads based on each ad's associated user profile constraints, device constraints, including cross-device sequencing, and frequency caps, in operation 606. For instance, one particular ad constraint specifies that this particular ad only applies to users are male. Accordingly, if the bid request is associated with a user u, who is female, this particular ad is filtered out from the candidate ads. In contrast, if another ad has an associated constraint specifying users are female and having an income of $40 k-50 k, this other ad is not filtered out for the ad request for an Oregon user and such other ad is deemed to be a candidate ad for further bid processing.

Each time a particular ad (or set of ads) was shown to a particular user/device or across a set of related devices, a count may have been tracked for the particular ad so that the ad can be only shown a predefined number of times in a particular time period, i.e., so as to meet the particular ad's frequency cap. For instance, if the ad's specified frequency cap is 5 ads being shown to a user per day across related devices of an aggregated user profile and the particular ad has already been shown on an aggregated user's mobile display 5 times during the day, then the particular ad is filtered from a user u who is associated with the same aggregated user profile, even if such user is currently using a related desktop computer, as opposed to the device associated with the current bid request.

Referring back to FIG. 6, bids may then be determined for each of the filtered ads based on the ad's associated campaign parameters, including goals such as a CPA, in operations 608. For an ad having a CPA, the bid b may be computed as:

b=p(u;w;a)×CPA

where p(u;w; a) is the probability of action given u, w, the ad a, and optionally other related parameters in the bid computation context. This probability may be computed using any suitable techniques, such as a machine learning algorithm. Several example techniques are described in the paper: D. Agarwal, R. Agrawal, and R. Khanna, “Estimating rates of rare events with multiple hierarchies through scalable log-linear models”, ACM SIGKDD Conf. on Knowledge Discovery and Data Mining, 2010, which paper is incorporated herein by reference for providing a technique for determining probability of an actions, such as user conversion or other actions with respect to impressions. Probability of conversion depends on past conversion rates of particular users with respect to particular media content and location, ad placement, and context.

Of course, CPA may be replaced with a CPC or CPM value (converted to a cost per impression). At least some input for determination of this probability p is provided in the bid request itself. In the CPM example, the bid b may be set equal to the advertiser specified CPM minus the fees charged by the DSP.

The bid determination techniques described herein may also factor in the corresponding ad campaign or package budget and a specified time frame for such budget to be spent. For instance, if ad purchases for a particular campaign are underspent by more than a predefined amount, the bid amounts may be increased. Likewise, if the ad purchases are overspent by more than another predefined amount, the bid amounts may be decreased. Moreover, a campaign budget can be periodically allocated to different packages of a campaign using an algorithm. The periodic allocation can consider the spend amount and performance levels of each package for allocating more or less budget to these packages.

Going back to FIG. 6, the best bid and its associated ad specifications may be found and sent to the ad exchange system, which sent or forwarded the bid request, in operation 610. For example, the DSP responds back to the bid request sender, e.g., RTB exchange, with its best bid and information on the corresponding ad, specifying how to retrieve the best bid's ad's creative content (e.g., the actual image corresponding to the ad). The RTB exchange then sends its best bid (selected from all DSP best bids) back to the bid request sender (or publisher). Out of all bids that are received by a bid exchange from all associated DSPs, the bid exchange may also send the highest bid out of the determined bids and associated ad specification to the publisher for display in the ad space.

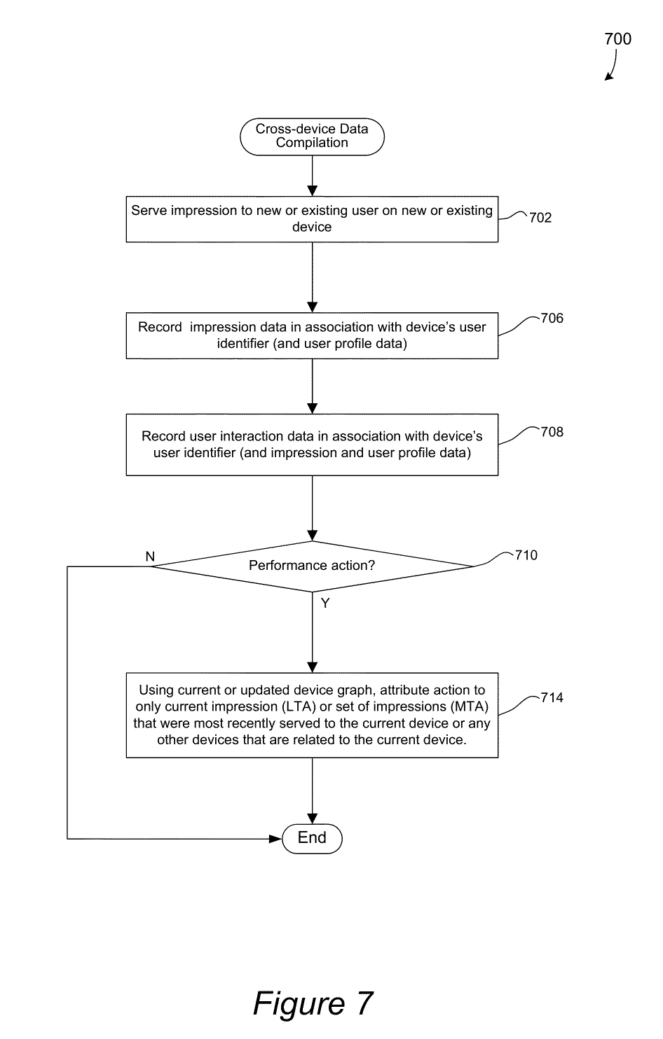

While impressions are being served to users who are associated with aggregated user profiles, cross-device data may be compiled for such users. FIG. 7 is a flow chart illustrating a technique 700 for cross-device data compilation in accordance with a specific implementation of the present invention. Initially, an impression may be served to a new or existing user on a new or existing device in operation 702.

Impression data may then be recorded in association with the particular device's user identifier, as well as the previously recorded user profile data, in operation 706. User interaction data may then be recorded in association with the current device's user identifier (and previously recorded impression and user profile data) in operation 708. The user identifier may be an existing or newly assigned user identifier for the current device. For example, if a user interacts via a particular device with the served impression (e.g., clicking on or moving a mouse over the creative, purchasing a product associated with the advertisement, etc.), data regarding such interaction type and time are recorded in association with the device's user identifier. In other examples, the recorded interaction data may include marketing engagement data for type, frequency, quantity, and time of engagement (or any other suitable engagement parameter).

It may also be determined whether a performance action has occurred in operation 710. For instance, an advertiser may define a performance action as a conversion or a click with respect to the ad. Conversions may take any suitable form, such as an advertisement viewer purchasing a product, filling out a form, signing up for e-mails, and/or performing some other type of action.

If the impression has no associated performance action (by the user), the process 700 ends. If there is a performance action, the action may be attributed to only the current impression in a last touch attribution (LTA) approach or attributed to a set of impressions that were most recently served to the current device or any other devices that are related to the current device in a multi-touch attribution (MTA) approach using the current or an updated device graph (or aggregated profile device graph) in operation 714.

In general, recorded data may be aggregated or associated with two or more related devices/users at any suitable time. In the data copy aggregation technique, data can be copied immediately to each related device when such data is made available, e.g., new user profile data is obtained for a device that is related to one or more other devices. Alternatively, such data aggregation may occur periodically after predefined time periods. In the data traversal procedure, data can be maintained in association with the device upon which the data was obtained, while each set of related devices are referenced to each other under a unique aggregate profile name (e.g., FIG. 4C).

The data that is compiled for user activity on related devices may be used to determine performance metrics for any combination of user profile characteristics across one or more related devices. Performance metrics may be determined for particular audience segments, devices, device sequencing, or the like at any suitable time. For instance, it may be determined which aggregated user profiles are more valuable to a particular advertiser. That is, an audience definition can be obtained and analyzed across related devices. In one example, some devices may only specify a male gender, while other related devices are associated with users who are skateboard enthusiasts. When the related device data is aggregated, it may be determined that users who are male and skateboarders are more valuable to an advertiser than users who are only male or only skateboarders. In another example, some devices may be associated with user data indicating interest in baby products, while other related devices may be associated with professional data indicating a high income. The aggregated user data in this later example may be used to promote high-end baby products to such users across one or more of their related devices.

Performance metrics may be determined at the request of an advertiser or marketing agent/system. Performance metrics may be determined by any general marketing platform, such as one or more DSP and/or DMP in cooperation with each other or with one or more 3^{rd} party systems. Although the following example implementations are described in terms of a DSP, techniques and mechanisms of certain embodiments may be implemented on any suitable type and number of marketing systems, such as DSP, DMP, a DMP that serves multiple DSP's, etc.

A DSP may also automatically determine performance metrics at predefined time intervals or after specified trigger events, such as during or after execution of a campaign, etc. In general, performance metrics may be determined for one or more audience segments, device types, or device sequences, or any combination thereof. The performance metrics may also correspond to all or a portion of the specification of a campaign or its different packages. Performance metrics may be determined for multiple packages or a single package, an expansion or reduction of one or more package's audience segments (i.e., performance metrics are calculated for a smaller or larger audience segment than is specified in a campaign package), etc. Techniques and mechanisms for optimizing audience segments by expanding or reducing audience segments of a campaign package are further described in U.S. patent application Ser. No. 14/132,293, filed 18 Dec. 2013, by Neil Shah et al., which application is incorporated herein by reference in its entirety. Similar techniques may be used to determine performance metrics for reducing or expanding audience segments, device specifications, or device sequencing specifications as specified in one or more campaign packages.

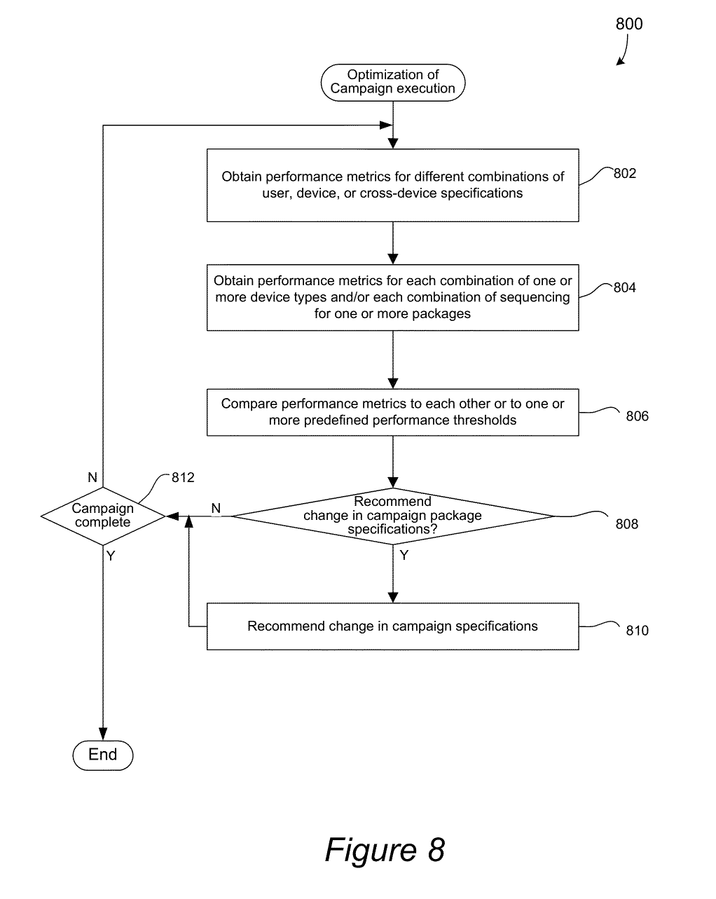

Performance metrics may be determined for various reasons, such as to optimize a campaign or provide a report. FIG. 8 illustrates a procedure 800 for optimization of campaign execution in accordance with one embodiment of the present invention. The following optimization process may be implemented for an advertiser's campaign, including all or a portion of their packages.

Initially, performance metrics for different combinations of user, device, or cross-device specifications may be obtained in operation 802. For example, conversion rates can be obtained for different audience segments as aggregated across related devices. In one example, a conversion rate for females having an income of $40 k-50 k may be determined from conversion activity on any related device that is associated with a user profile specifying that the user is female and/or an income of $40 k-50 k. In the example of FIG. 4C, the conversion on device D2 counts as a conversion for a female having a $40 k-50 k income based on the aggregated profile obtained from device D1, which is associated with a female user, and device D2, which is associated with an income of $40 k-50 k. The conversion counts for a particular audience segment across related devices can be multiplied by a return amount and then the total return amount can be compared to the advertisement investment for the particular audience segment to obtain a return on investment (ROI) amount.

Performance metrics may also be obtained for each combination of one or more device types (e.g., mobile vs. desktop/laptop) and/or each combination of device sequencing for one or more packages in operation 804. In a device type example, performance metrics may be determined for an aggregated user (or household) who has 2 tablets and 2 mobile phones or an aggregated user who has at least two display type devices (e.g., desktop or laptop). In a sequencing example, ROI may be determined for a creative that is shown in a first order (mobile-->display-->mobile) and a second order (mobile-->mobile-->display). Performance metrics may be calculated for any suitable number of sequences. Performance metrics may also be obtained for each different sequence and each different audience segment combination. Performance metrics may also be obtained for different frequency caps for one or more device types, audience segments, and/or one or more impressions.

The above examples merely represent a few of the different package parameters that can be analyzed for performance. Other parameters for which a performance metric may be determined include different user profile characteristics, different ad space characteristics (e.g., top or bottom), different devices, different combinations of number and types of related devices, different publisher characteristics, etc.

Performance metrics can also be compared to each other or to one or more predefined thresholds in operation 806. For instance, it may be determined which audience segment, whether such audience segment is equivalent to a current package or a sub-portion or expansion of a current package, has the most value for the advertiser. For instance, if a current package has a particular audience segment that combines particular user profile characteristics (e.g., via a Boolean expression), an audience segment that has fewer or more user profile characteristics may be determined to result in better performance than the current package.

After a comparison of performance metrics is performed, it may be determined whether to recommend a change in campaign specifications in operation 808. If a recommendation is to be made, the change in campaign specifications is recommended in operation 810. For example, a recommendation to add or remove a user profile characteristic from a package may be presented to the advertiser. If no change is to be recommended or after a change is recommended, it may then be determined whether the campaign is complete upon which the optimization process 800 may end. Otherwise, the optimization process is repeated for the currently executing campaign. The advertiser or DSP may also choose to bid higher for more valuable audience segments, including device types and sequencing combinations, which are obtained through aggregated profile data.

If a recommendation is not be made, it may be determined whether the campaign is compete in operation 812. If complete, the campaign optimization process may end. Otherwise, the procedure 800 may be repeated.

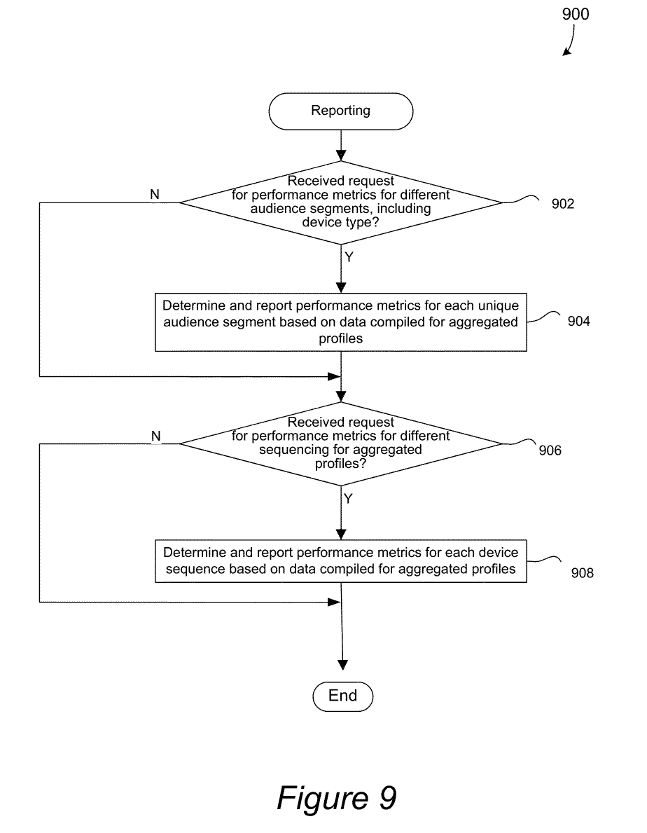

FIG. 9 is a flow chart illustrating a reporting procedure in accordance with one simple embodiment of the present invention. It may be determined whether a request for performance metrics for different combinations of audience segments, including device type(s), has been received, for example, for the advertiser or advertiser agent in operation 902. Alternatively, the reporting process may be initiated automatically without input from the advertiser.

If a request has been received or the reporting process has been automatically initiated, performance metrics for each unique audience segment may be determined and reported based on data compiled for aggregated profiles in operation 904. Reports may be generated based on any combination of audience parameters, such as one or more user profile characteristics, one or more particular types and number of devices, etc. This reporting step may also be skipped, for example, if a request has not been received.

It may also be determined whether a request for performance metrics for different sequencing combinations for aggregated profiles has been received in operation 906. If such a request has been received (or this reporting option is automatic), performance metrics for each device sequence may be determined and reported based on data compiled for aggregated profiles in operation 908. This reporting step may be skipped if a corresponding request has not been made or this report is not automatically generated.

Based on the device graphs, aggregated user profile data, and references to aggregated user profiles (e.g., the traversal data of FIG. 4C), any portion of any user, ad, or publisher data that is associated with a particular device that has one or more related devices may be analyzed and used to determine and report performance metrics at any suitable time. For example, any user profile data sub-portion of the aggregated data may be analyzed separately over time. Additionally, any user profile data sub-portion can be analyzed with respect to any combination of related devices based on aggregated related devices and their data that is recorded over time. In other words, different user characteristics can be merged together across related or aggregated devices to determine performance by users having merged characteristics.

Additionally, an average user flow to perform a particular action, such as conversion, may be determined. For instance, an average purchaser of product X may be a user who views a particular ad on her mobile device and then converts on a display device, rather than a user who views an impression only on her mobile.

Specific events may be recorded for specific devices over time and then later analyzed together so as to obtain a more complete picture of events that were performed by aggregated related devices and users for a predefined period of time. In other words, events associated with an aggregated set of related devices and its one or more users may be analyzed during a specific timeline. The aggregated data can also be broken into any useful data portions and analyzed to determine which user audience segments, devices, sequencing, frequency caps are more valuable for a particular advertising campaign or brand.

Additionally, aggregated user profiles may optionally be generated, analyzed, or traversed when particular confidence metric thresholds are met. For instance, sequencing combinations are only analyzed with respect to devices that have a probability of being related that is over 75%.

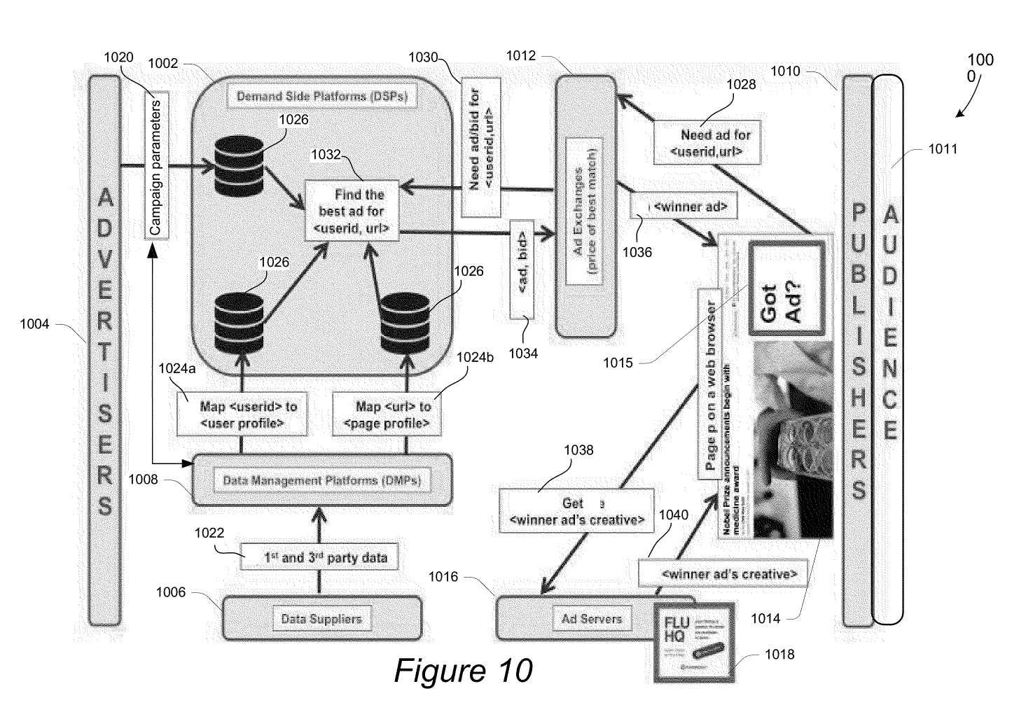

Techniques of the present invention may be practiced in any networking environment. FIG. 10 is a diagrammatic representation of an example advertisement system in which techniques of the present invention may be implemented. A real-time bidding flow will be generally described with respect to this system 1000. At a high level, this flow can be considered in three main sections: the demand side on the left, the ad exchange 1012 in the middle, and the supply side on the right. In reality, a real-time bidding ecosystem is fairly complex and may include any suitable number and type of components for providing advertisements to audience users.

Publishers 1010 may provide any suitable type of displayable, executable, audible, or visual media content to users/audience 1011 via a user's device or on the publisher's device or system. For example, media content may include videos, music, text, games, etc. The content may also pertain to various categories, such as news, entertainment, educational, finance, sports, travel, etc. In a specific implementation, publishers provide media content, such as web pages, from server devices to client devices that are accessible by audience members/users. Example client devices include tablet computing devices, laptop computing devices, personal digital assistant (PDA) devices, mobile phones (e.g., smart phones), desktop computer, televisions, wearable computers, household devices, etc. Each client device may be configured with any suitable hardware and/or software (e.g., one or more browsers and/or browser add-ins plug-ins, operating systems for downloading and execution of apps on mobile devices) that operates in cooperation with the publisher devices/systems for receiving and presenting media content.

Prior to providing requested media content to users 1011, the Publishers 1010 may also sell ad spaces with respect to such media content. Advertisers 1004 at the demand side have ads to place with publisher-provided media content. For instance, an advertiser 1004 pays to have an ad placed in an ad space of a particular web page that is sold by a publisher. Although the following system 1000 and flow is described with respect to ad spaces in web pages, the following processes may be implemented for other types of ad spaces in other types of media, such as mobile device apps, games, coupons, videos, etc.

The ad exchange system 1012 generally runs an auction to determine a price of a match between an ad and a web page. In essence, ad exchanges are the markets providing mechanisms for facilitating bidding processes between the demand and supply sides. The ad exchanges may be implemented on any suitable number and type of computing devices.

Demand side platforms (DSPs) 1002 may be generally configured to manage advertising campaigns on behalf of advertisers 1004 although some advertisers may also work directly with ad exchanges. Given a user requesting a particular web page, a DSP 1002 is able to find the best ad for the user (1011). The best ad may be selected from the ads managed by the DSP as described above. For each ad selected, various constraints (mostly selected by the advertisers, but some by the ad exchange, the publisher, and the DSP) are met.

DSP may receive, determine, and store user and page profiles, as well as device graphs and aggregate profile device graphs, in an accessible profile database (such as 1026 of FIG. 10), which may be implemented by any suitable type and number of storage devices. The DSPs 1002 may obtain the user profile and page profile data from a plurality of data management platforms (DMPs) 1008, which may be configured to aggregate and data-mine all kinds of advertising and non-advertising data. One specific use of DMPs is to extend the audience known to an advertiser through analysis of various audience data from various third-party data vendors. A DSP may be integrated with its DMP or other third-party DMPs.

The user and media content profile data may be obtained or accessible as 1^{st} and 3^{rd} party data (1022) from various data suppliers (1006), such as first parties (the advertisers themselves) or third parties (independent data suppliers). In the example of FIG. 10, the DSPs 1002 may obtain mappings between user profile data and user IDs (1024a) and mappings between page profile data and universal resource locators or URLs (1024b). As described above, user and/or media content profile data may be provided in bid requests by the publisher.

The user profile data is preferably fully anonymized so as not to contain any personally identifiable information. For instance, a user login, device identity (such as MAC address) may be associated with user profile information, which does not include the user's actual name or address, etc. Similarly, a unique identity for the specific media content (and/or ad space) may be associated with specific characteristics.

Advertisers who work with a DSP may provide campaign parameters or specifications (1020) to the DSP. The advertisers may specify any suitable campaign parameters for running a particular ad campaign. For each campaign, an advertiser may specify at least a budget, an ad, a goal, and a set of constraints, sometimes referred to as targeting or contextual constraints. An ad campaign's budget may be specified to be spent over a given time period, sometimes referred to as a budget schedule.

For a branding type campaign, the idea may be to reach as many unique users as the campaign budget affords at a cost per impression. This goal may be expressed as CPM, the cost per mille or one thousand impressions. For a performance type campaign, the advertiser may wish to reach as many unique users as the campaign budget affords but to do so while keeping within certain performance goals. The performance goals may be expressed as CPC or CPA, the cost per click or the cost per action or conversion, respectively, although there may be other performance goals depending on the media content type, e.g., cost per engagement for a video advertisement. The goal associated with a segment of users may reflect the value of reaching those users for the advertiser. In advertising terminology, the part of the campaign customized to this segment of users is sometimes called a package. The term CPA may be used herein for both CPA and CPC for brevity and without loss of generality.

An advertiser may also specify targeting constraints for an ad campaign as described further above. In general, constraints may specify what kind of users to reach on what kind of media content, how long to run the campaign, etc. A single user constraint can serve to partition a set of users into user segments that include users who satisfy the constraint and users who do not. In general, constraints can be based on any combination of characteristics from a particular user's profile, a particular media content profile, or other parameters that are obtainable for a particular ad request. Example constraints may pertain to user demographics, user browsing history, user geographic location data, media content categories, ad or ad space/placement characteristics, user contextual parameters (e.g., weather, time of day, stock market indexes, etc.), advertiser categories, etc. In general, user contextual parameters may include any contextual parameter that may affect a user or advertiser's behavior.

Referring back to FIG. 10, a publisher 1010 may also work with an ad exchange 1012 to find bid for advertisers to sell ads for use in the publisher's pages. When a user u with a user ID <userid> is about to view a web page w 1014 with URL <url> from the publisher, the publisher sends an ad request 1028 for an ad to be sold for a particular ad space 1015 of the web page w 1014 to the ad exchange 1012. The ad exchange 1012 passes the request 1030 to all partner DSPs 1002.

Embodiments of the present invention may be implemented in any suitable network systems. The network may take any suitable form, such as a wide area network or Internet and/or one or more local area networks (LAN's). The network may be in the form of a data, mobile, cellular, plain old telephone network (POTN), or any combination thereof. Referring back to FIG. 10, the network 1000 may include any suitable number and type of devices, e.g., routers and switches, for forwarding requests from each client to a particular server application, forwarding application results back to the requesting clients, or forwarding data between various servers or processing devices.

Embodiments of the present invention may also be practiced in a wide variety of network environments including, for example, TCP/IP-based networks (e.g., Rate Control Protocol or RCP, Transport Control Protocol or TCP, Fast TCP, Stream-based TCP/IP or STCP, eXplicit Control Protocol or XCP, etc.), telecommunications networks, wireless networks, mobile networks, etc., or any combination thereof. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be affected or employed at different locations.

The disclosed techniques of the present invention may be implemented in any suitable combination of software and/or hardware system, such as a web-based server or desktop computer system. An apparatus for implementing one or more portions of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

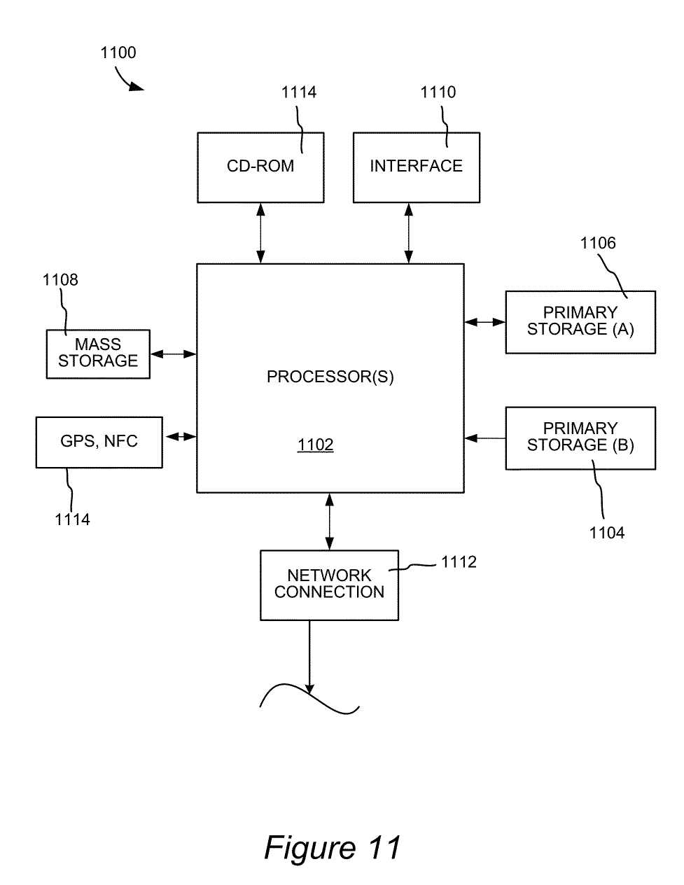

FIG. 11 illustrates a typical computer system that, when appropriately configured or designed, can serve as a bid determination system for implementing at least portions of the process embodiments described herein. The computer system 1100 includes any number of processors 1102 (also referred to as central processing units, or CPUs) that are coupled to storage devices including primary storage 1106 (typically a random access memory, or RAM), primary storage 1104 (typically a read only memory, or ROM). CPU 1102 may be of various types including microcontrollers and microprocessors such as programmable devices (e.g., CPLDs and FPGAs) and unprogrammable devices such as gate array ASICs or general-purpose microprocessors. As is well known in the art, primary storage 1104 acts to transfer data and instructions uni-directionally to the CPU and primary storage 1106 is used typically to transfer data and instructions in a bi-directional manner. Both of these primary storage devices may include any suitable computer-readable media such as those described herein. A mass storage device 1108 is also coupled bi-directionally to CPU 1102 and provides additional data storage capacity and may include any of the computer-readable media described herein. Mass storage device 1108 may be used to store programs, data and the like and is typically a secondary storage medium such as a hard disk. It will be appreciated that the information retained within the mass storage device 1108, may, in appropriate cases, be incorporated in standard fashion as part of primary storage 1106 as virtual memory. A specific mass storage device such as a CD-ROM 1114 may also pass data uni-directionally to the CPU.

CPU 1102 is also coupled to an interface 1110 that connects to one or more input/output devices such as such as video monitors or displays, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1102 optionally may be coupled to an external device such as a database or a computer or telecommunications network using an external connection as shown generally at 1112. With such a connection, it is contemplated that the CPU might receive information from the network, or might output information to the network in the course of performing the method steps described herein. CPU 1102 may also be coupled with any other suitable internal devices, such as a GPS device or NFC device 1114 although these devices may be more applicable to client devices.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

A network may also include mass storage, such as network attached storage (NAS), a storage area network (SAN), or other forms of computer or machine readable storage media, for example. Regardless of the system's configuration (e.g., client or server), it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the present invention relates to machine readable storage media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

1. A method for facilitating on-line advertising or marketer engagement over a computer network, the method comprising:
in a processing system for facilitating on-line advertising or marketer engagement on physical user devices, obtaining a device graph representing a plurality of devices and a plurality of confidence scores that indicate probabilities of specific related ones of the devices being associated with a same user or a closely related set of users based on user on-line activity with such devices, wherein the device graph include a user identifier for each device;
periodically obtaining a plurality of sets of activity data that is each associated with user profile data and a specific one of the user identifiers of the device graph and associating such obtained user profile and activity data with their respective user identifiers, wherein each set of activity data includes advertisement or marketer engagement activity data;
creating or updating an aggregated profile device graph for each set of related devices by performing a data distribution procedure that includes copying each related device's user profile data to be associated with the user identifier of each other related device that was not associated with such copied user profile data prior to the copying and such copying is based on whether each set of related devices are associated with confidence scores from the device graph that are above a predetermined threshold, wherein at least some of the user profile data that are copied include gender and age user profile data, wherein the data distribution includes associating different unique aggregated profile identifiers with different sets of related devices' user identifiers and their associated user profile data;
providing the updated aggregated profile device graph in a database that is accessible by a processor that is programmed to perform targeted advertising or marketer engagement over a computer network based on specified user profile constraints being met by combined user profiles from related devices.

2. The method of claim 1, wherein the user identifier for each device is associated with a physical device identifier or an application identifier.

3. (canceled)

4. The method of claim 1, wherein at least a portion of the confidence scores indicate probabilities of specific related ones of the devices being associated with a closely related set of users in the form of a household based on user on-line activity with such devices.

5. The method of claim 1, wherein the user profile data and advertisement or marketer engagement activity data that is obtained periodically for each device originates from a plurality of different data sources including a plurality of advertisers or advertiser agents, one or more bid management systems, and a plurality of third party sources.

6-7. (canceled)

8. The method of claim 1, further comprising:
(i) determining campaign user and device constraints for each of a plurality of advertisements;
(ii) at a communication interface of a bid determination platform, receiving a bid request associated with user data and/or device data for a first device;
(iii) obtaining user profile data that is combined together for the first device and other devices related to the first device based on the user data and/or device data of the bid request and the aggregated profile device graph;
(iv) determining a plurality of bids for a portion of the advertisements via a computer processor of the bid determination platform based on the user data, the device data, and the user profile data that is combined together for the first device and its other related devices meeting the campaign user and device constraints associated with each advertisement from the portion of advertisements; and
(v) transmitting the optimum one of the bids, along with a reference to the associated advertisement, via the communication interface towards a sender of the bid request.

9. The method of claim 8, wherein at least one of the device constraints specifies a sequencing of device types for displaying the associated advertisement with respect to related devices.

10. The method of claim 8, wherein at least one of the device constraints specify a frequency cap for displaying the associated advertisement across related devices.

11. The method of claim 1, wherein the user profile data from at least a first set of related devices pertains to a same user or household who uses the first set of related devices.

12. The method of claim 1, wherein the user profile data for each set of related devices is obtained in response to user activity on different ones of the set of related devices.

13. The method of claim 1, wherein, for each device of at least a portion of the device graph, marketer engagement activity data is periodically obtained and associated with such device's user identifier.

14. The method of claim 1, further comprising:
(i) determining user and device constraints for a content portion;
(ii) at a communication interface of a marketing platform, receiving a content request associated with user data and/or device data for a first device;
(iii) obtaining user profile data that is combined together for the first device and other devices related to the first device of the content request based on the user data and/or device data of the content request and the aggregated profile device graph;
(iv) determining via a computer processor of the marketing platform whether to provide the content portion based on the user data, the device data, and the user profile data that is combined together for the first device of the content request and its other related devices meeting the content user and device constraints; and
(v) if the content user and device constraints are met, transmitting a reference to the content portion via the communication interface towards a sender of the content request.

15. A system for bidding on placement of advertisements within media content that is deliverable within a computer networking environment, the system comprising at least a processor and a memory, wherein the processor and/or memory are configured to perform the following operations:
obtaining a device graph representing a plurality of physical devices and a plurality of confidence scores that indicate probabilities of specific related ones of the devices being associated with a same user or a closely related set of users based on user on-line activity with such devices, wherein the device graph include a user identifier for each device;
periodically obtaining a plurality of sets of activity data that is each associated with user profile data and a specific one of the user identifiers of the device graph and associating such obtained user profile and activity data with their respective user identifiers, wherein each set of activity data includes advertisement or marketer engagement activity data, wherein at least some of the sets of activity data are specified as belonging to different ones of the user identifiers that have different related devices and their different user profiles, including different genders and age ranges;
creating or updating an aggregated profile device graph for each set of related devices by performing a data distribution procedure that includes copying each related device's user profile data to be associated with the user identifier of each other related device that was not associated with such copied user profile data prior to the copying based on whether each set of related devices are associated with confidence scores from the device graph that are above a predetermined threshold, wherein the data distribution includes associating different unique aggregated profile identifiers with different sets of related devices' user identifiers and their associated user profile data;
providing the updated aggregated profile device graph in a database that is accessible by a processor that is programmed to perform targeted advertising or marketer engagement over a computer network based on specified user profile constraints being met by combined user profiles from related devices.

16. The system of claim 15, wherein data distribution procedure results in at least some sets of related devices each being associated with a same set of user profile data.

17. The system of claim 15, wherein the processor and/or memory are further configured for:
(i) determining campaign user and device constraints for each of a plurality of advertisements;
(ii) at a communication interface of a bid determination platform, receiving a bid request associated with user data and/or device data for a first device;
(iii) obtaining user profile data that is combined together for the first device and other devices related to the first device based on the user data and/or device data of the bid request and the aggregated profile device graph;
(iv) determining a plurality of bids for a portion of the advertisements via a computer processor of the bid determination platform based on the user data, the device data, and the user profile data that is combined together for the first device and its other related devices meeting the campaign user and device constraints associated with each advertisement from the portion of advertisements; and
(v) transmitting the optimum one of the bids, along with a reference to the associated advertisement, via the communication interface towards a sender of the bid request.

18. The system of claim 17, wherein at least one of the device constraints specifies a sequencing of device types for displaying the associated advertisement with respect to related devices.

19. The system of claim 18, wherein at least one of the device constraints specify a frequency cap for displaying the associated advertisement across related devices.

20. The system of claim 15, wherein the user profile data from at least a first set of related devices pertains to a same user or household who uses the first set of related devices.

21. The system of claim 15, wherein the user profile data for each set of related devices is obtained in response to user activity on different ones of the set of related devices.

22. The system of claim 15, wherein the processor and/or memory are further configured for:
(i) determining user and device constraints for a content portion;
(ii) at a communication interface of a marketing platform, receiving a content request associated with user data and/or device data for a first device;
(iii) obtaining user profile data that is combined together for the first device and other devices related to the first device of the content request based on the user data and/or device data of the content request and the aggregated profile device graph;
(iv) determining via a computer processor of the marketing platform whether to provide the content portion based on the user data, the device data, and the user profile data that is combined together for the first device of the content request and its other related devices meeting the content user and device constraints; and
(v) if the content user and device constraints are met, transmitting a reference to the content portion via the communication interface towards a sender of the content request.

23. At least one non-transitory computer readable storage medium having computer program instructions stored thereon that are arranged to perform the following operations:
in an processing system for facilitating on-line advertising or marketer engagement on physical user devices, obtaining a device graph representing a plurality of devices and a plurality of confidence scores that indicate probabilities specific related ones of the devices being associated with a same user or a closely related set of users based on user on-line activity with such devices, wherein the device graph include a user identifier for each device;
periodically obtaining a plurality of sets of activity data that is each associated with user profile data and a specific one of the user identifiers of the device graph and associating such obtained user profile and activity data with their respective user identifiers, wherein each set of activity data includes advertisement or marketer engagement activity data, wherein at least some of the sets of activity data are specified as belonging to different ones of the user identifiers that have different related devices and their different user profiles, including different genders and age ranges;
creating or updating an aggregated profile device graph for each set of related devices by performing a data distribution procedure that includes copying each related device's user profile data to be associated with the user identifier of each other related device that was not associated with such copied user profile data prior to the copying based on whether each set of related devices are associated with confidence scores from the device graph that are above a predetermined threshold, wherein the data distribution includes associating different unique aggregated profile identifiers with different sets of related devices' user identifiers and their associated user profile data;
providing the updated aggregated profile device graph in a database that is accessible by a processor that is programmed to perform targeted advertising or marketer engagement over a computer network based on specified user profile constraints being met by combined user profiles from related devices.

24. The system of claim 15, wherein the user identifier for each device is associated with a physical device identifier or an application identifier.

25. The system of claim 15, wherein at least a portion of the confidence scores indicate probabilities of specific related ones of the devices that have been determined to be associated with a closely related set of users in the form of a household based on user on-line activity with such devices.
